(19) United States
(12) Patent Application Publication
(10) Pub. No.: US 2004/0020066 A1
(43) Pub. Date: Feb. 5, 2004

(54) Siding revealer gauge

(76) Inventor: Walter L. Morey, Battleground, WA (US)

Correspondence Address: WALTER L. MOREY, 12701 N.E. 291st ST., Battleground, WA, 98604, US

(21) Appl. No.: 10/210,533

(22) Filed: Aug. 2, 2002

(51) Int. Cl. G01D 21/00

(52) U.S. Cl. 33/647

(57) ABSTRACT

The Siding Revealer Gauge is a lightweight tool that when used properly will repeatedly give exactly the same measurement between layers of siding boards, shingles, and other flat materials installed in an overlapping fashion. Said lightweight tool also allows said overlapping flat materials to be installed much faster then with any tools already existing in the art of hanging said overlapping flat materials. The Siding Revealer Gauge has a handle attached to a back surface, a level top surface, and a ledge protruding from a front surface. The ledge protruding from the front surface of the gauge is placed against the butt of an installed piece of said material. The front face of the gauge should be held firmly against said flat material. The butt of the next layer of flat material should be laid across the top surface of the gauge. The top surface of the gauge is of sufficient length and width to allow the butt of the next layer of material being worked with to be held firmly against said top surface without unreasonable wobbling. Once the new piece of material has been secured in place the process is repeated across the row of material and upwards creating new rows as needed.

### CROSS REFERENCE TO RELATED APPLICATIONS

Not applicable

### BACKGROUND STATEMENT REGARDING FEDERALLY SPONSORED RESEARCH OR DEVELOPMENT

Not applicable

### REFERENCE TO MICROFICHE INDEX

Not applicable

### BACKGROUND FIELD OF INVENTION

This invention relates to those sorts of devices that serve to facilitate the instillation of siding boards, shingles, and other flat materials installed in an overlapping fashion.

### BACKGROUND-DISCUSSION OF PRIOR ART

Existing tools for the art of installing siding boards, shingles, and other flat overlapping materials, are hard to work with and leave much to be desired. Many existing tools for said art are too heavy to be practical. Most existing tools involve a process of wedging a metal clamp between two overlapping pieces of material being installed. Said metal clamps will often scratch the surface of said material. Many existing tools also involve some form of sliding ruler. Said sliding rulers are not capable of giving exactly the same measurement each and every time used. This lack of precision on the part of slide rulers can cause severe problems and delays when working in said art. Many forms of prior art also lack stability when being used. This lack of stability can cause accidents.

### SUMMARY

A lightweight tool that when used properly will repeatedly give exactly the same measurement between layers of siding boards, shingles, and other flat materials installed in an overlapping fashion. Said lightweight tool also allows said overlapping flat materials to be installed much faster then with any tools already existing in the art of hanging said overlapping flat materials.

Objects and Advantages:

Accordingly, this invention has several objects and advantages superior to prior art. It can comfortably be used with one hand. It can support the next layer of material being installed without the use of metal clamps. And it can give precisely the same measurement each and every time. It has greater stability than prior art making it safer to work with. Because of its advantages over prior art this invention is also much faster to use then all prior art. Further objects and advantages of this invention will become apparent from a consideration of the drawings and ensuing description.

### DESCRIPTION OF DRAWING

FIG. 1 is a front/side perspective drawing of the Siding Revealer Gauge

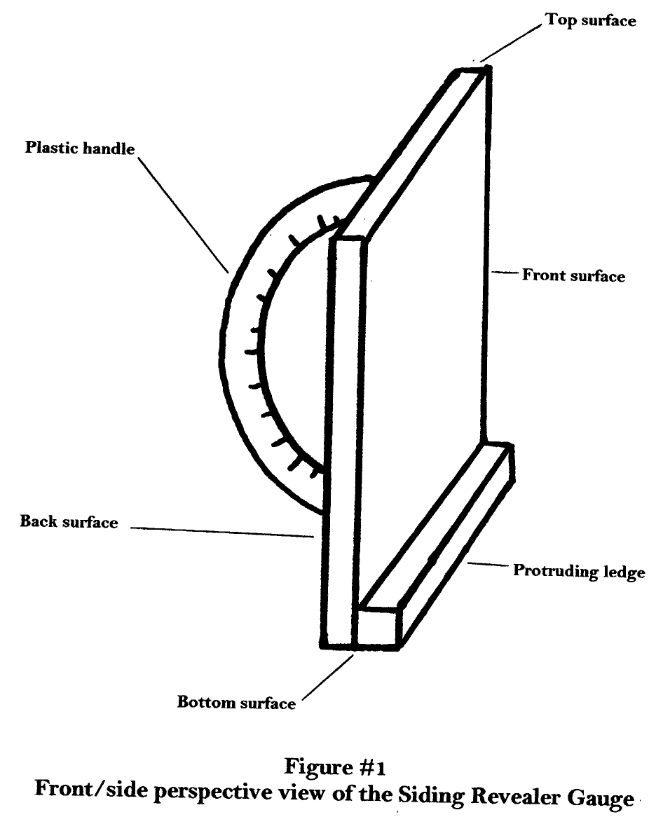

### DESCRIPTION OF INVENTION

FIGURE one shows a perspective view of the preferred embodiment of the Siding Revealer Gauge. The main body of said embodiment is crafted from one solid piece of aluminum. A plastic handle is attached to a back surface by means of screws. Said back surface is a 7-½ inch by 3-½ inch rectangle. Said rectangle is ½ inch thick creating a ½ inch by 3-½ inch top surface parallel to a bottom surface. Said bottom surface is 3-½ inches wide and extends 1 inch from said back surface creating ½ inch ledge protruding from the bottom of a front surface. Said front surface is a rectangle 7 inch by 3-½ inch extending from the upper side of said ledge to the top surface.

Operation of Invention:

This invention is intended to facilitate the installation of flat materials installed in an overlapping fashion. Once a bottom row of said flat material has been installed it is necessary to install another row of said flat material positioned with a precise amount of overlap. First, a Siding Revealer Gauge must be selected with a front surface length capable of corresponding to the desired amount of material left exposed after installing the next layer of overlapping material. To get said precise measurement of overlap the protruding ledge of the gauge is placed against the butt of an installed piece of said material. The front face of the gauge should be held firmly against said flat material. The butt of the next layer of flat material should be laid across the top surface of the gauge. The top surface of the gauge should be of sufficient length and width to allow the butt of the next layer of material being worked with to be held firmly against said top surface without unreasonable wobbling. Once the new piece of material has been secured in place repeat the process across the row of material and upwards creating new rows as needed.

Description and Operation of Alternative Embodiments:

It would be possible for other tools commonly used when installing overlapping flat materials such as levels, straight edges, etc., to be incorporated into the Siding Revealer Gauge. This would reduce the number of individual tools needed to be carried. The Siding Revealer Gauge can be designed to give any precise measurement desired by making necessary alterations to the length of the main body and positioning of the protruding ledge. The siding revealer gauge does not have to be made of aluminum. It can be made of any sturdy material such as other metals, plastic, wood, etc.

The main body of the siding revealer gauge does not have to be one solid piece. It can be made integrally or separately as long as all pieces are fixed securely in place. The handle of the siding revealer gauge does not have to be made of plastic. It can be made of any sturdy material such as plastic, wood, metal, etc. The Siding Revealer Gauge could be designed with gaps in any or all of the surfaces and components of the tool provided all components where still able to perform their essential functions. Incorporating such gaps into the design would reduce the weight of the tool. The general rectangular shape and square edges could be altered provided all essential components claimed where still present.

Conclusion, Ramifications, and Scope of Invention:

Thus the reader will see that the Siding Revealer Gauge is a lightweight tool that can make the process of hanging overlapping flat materials much faster and easier than with prior art. The siding Revealer Gauge provides an exact measurement every time thus avoiding costly delays caused by slight mismeasurements. The Siding Revealer Gauge is also far more stable to work with than many forms of prior art thus avoiding many accidents. The Siding Revealer Gauge is also far less likely to ever damage or scratch material being installed than most prior art.

While the above description contains many specifications, these should not be construed as limitations on the scope of the invention, but rather as an exemplification of one preferred embodiment thereof Many other variations are possible. Accordingly, the scope of the invention should be determined not by the embodiment illustrated, but by the appended claims and their legal equivalents.

Sequence Listing:

Not applicable

1. A tool to aid the installation of overlapping flat materials comprising:
A. a top surface creating a level contact plain wide enough to contact the butt of a piece of said material without unreasonable wobbling,
B. a main body comprising a piece, or multiple pieces, of sturdy material extending down from said top surface,
C. a protruding ledge securely fixed to said main body a precise distance from said top surface creating a contact plain parallel to said top contact plain and wide enough to eliminate unreasonable wobbling.
